(19) United States
(12) Patent Application Publication
(10) Pub. No.: US 2014/0071852 A1
(43) Pub. Date: Mar. 13, 2014

(54) NETWORK SYSTEM

(71) Applicant: Sony Corporation, Tokyo (JP)

(72) Inventor: Osamu Matsunaga, Kanagawa (JP)

(73) Assignee: Sony Corporation, Tokyo (JP)

(21) Appl. No.: 14/019,917

(22) Filed: Sep. 6, 2013

(30) Foreign Application Priority Data
Sep. 13, 2012 (JP) 2012-201345

(51) Int. Cl. H04L 12/24

(52) U.S. Cl. CPC H04L 41/12
USPC 370/254

(57) ABSTRACT

Provided is a network system including a plurality of communication apparatuses, a packet relay apparatus, and a control apparatus. The plurality of communication apparatuses are configured to be capable of performing packet communication. The packet relay apparatus includes a plurality of networks for the packet communication and is configured to be connected to the plurality of communication apparatuses such that each of the plurality of communication apparatuses is connectable to at least two networks of the plurality of networks. The control apparatus is configured to select a network to be a connection destination from the plurality of networks and instruct each of the plurality of communication apparatuses to connect to the selected network via the packet relay apparatus.

### BACKGROUND

The present disclosure relates to a network system capable of performing packet communication.

For example, Japanese Patent Application Laid-open No. 2003-158539 (hereinafter, referred to as Patent Document 1) describes a network transfer system consisting of a plurality of nodes 10 to 40 and layer 2 switches 11 to 17 as shown in FIG. 1. The plurality of nodes 10 to 40 are connected through layer 2 network virtual local area networks (VLANs) 1 to 3 consisting of the layer 2 switches 11 to 17. Those layer 2 networks VLAN 1 to 3 are configured so as not to form a loop. With this, policy of administrator can be reflected in route setting to permit an effective use of the network resource and also permit quick restoration of failure (see paragraphs [0014]-[0016], [0060], and the like in specification of Patent Document 1).

### SUMMARY

As described above, a useful network system to be used in packet communication between a plurality of nodes is necessary.

In view of the above-mentioned circumstances, it is possible to provide a useful network system usable in packet communication between a plurality of communication apparatuses.

According to an embodiment of the present disclosure, there is provided a network system including a plurality of communication apparatuses, a packet relay apparatus, and a control apparatus.

The plurality of communication apparatuses are configured to be capable of performing packet communication.

The packet relay apparatus includes a plurality of networks for the packet communication and is configured to be connected to the plurality of communication apparatuses such that each of the plurality of communication apparatuses is connectable to at least two networks of the plurality of networks.

The control apparatus is configured to select a network to be a connection destination from the plurality of networks and instruct each of the plurality of communication apparatuses to connect to the selected network via the packet relay apparatus.

In this network system, the packet relay apparatus is provided such that each of the plurality of communication apparatuses is connectable to the at least two networks. Then, the control apparatus instructs each communication apparatus to connect to the network to be the destination connection. With this, a useful network system usable in the packet communication between the plurality of communication apparatuses is realized.

The packet relay apparatus may be configured to be connected to the plurality of communication apparatuses such that each of the plurality of communication apparatuses is connectable to all the plurality of networks.

In this network system, the packet relay apparatus is provided such that each of the plurality of communication apparatuses is connectable to all the plurality of networks. Then, the control apparatus instructs each communication apparatus to connect to the network to be the connection destination. With this, a useful network system usable in the packet communication between the plurality of communication apparatuses is realized.

The packet relay apparatus may include one or more layer 2 switches including a plurality of virtual local area networks (VLANs) as the plurality of networks.

In this manner, as the plurality of networks, the plurality of VLANs may be used.

The packet relay apparatus may be one or more layer 3 switches including a plurality of local area networks (LANs) as the plurality of networks.

In this manner, as the plurality of networks, the plurality of LANs may be used.

The packet relay apparatus may include, as one of the plurality of networks, a control network configured to be commonly connected to the plurality of communication apparatuses for the instruction of the control apparatus. In this case, the control apparatus may be configured to select the connection destination network from a plurality of communication networks of the plurality of networks excluding the control network and instruct each of the plurality of communication apparatuses to connect to the selected connection destination network through the control network.

In this network system, the control network is set as one of the plurality of networks. Then, through the control network, the connection destination network is selected from the plurality of communication networks and the instruction to connect to the selected connection destination network is provided.

The control apparatus may be configured to manage, using a cross-point expression, a system state including a connection state between the plurality of communication apparatuses, and connection states between the plurality of communication apparatuses and the plurality of networks.

The system state is managed by the cross-point expression, and hence the network system can be easily managed.

The control apparatus may be configured to output display information for displaying the system state by the cross-point expression.

With this, the system state can be displayed by the cross-point expression, and hence it becomes easy to grasp or manage the connection state of the network system, for example.

The control apparatus may be configured to transmit, as the instruction regarding the connection destination network, setting information including information on the connection destination network and an address of a communication apparatus to be a communication destination of the packet communication out of the plurality of communication apparatuses.

In this manner, the setting information including the information on the connection destination network and the address of the communication apparatus to be a communication partner may be transmitted from the control apparatus.

The communication apparatus may be configured to perform, based on the setting information received from the control apparatus, setting for the packet communication.

In this manner, based on the setting information from the control apparatus, the communication apparatus capable of performing setting for the packet communication may be used.

The communication apparatus may be configured to be connectable, with each of two or more networks of the plurality of networks being the network to be the connection destination, to two or more connection destination networks at the same time.

As the communication apparatus, one connectable to the two or more connection destination networks at the same time may be used.

The control apparatus may be configured to communicate, for the instruction, with the communication apparatus by a simple network management protocol (SNMP).

In this manner, the control apparatus and the communication apparatus may be communicable with each other by the SNMP.

As described above, according to the embodiment of the present disclosure, it is possible to realize a useful network system usable in packet communication between the plurality of communication apparatuses.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a diagram for explaining an outline of a network system according to a first embodiment of the present disclosure;

FIG. 2 is a view showing a configuration example of the network system according to the first embodiment;

FIG. 3 is a view showing an example of a cross-point expression to be used for managing a connection state of the network system shown in FIG. 2;

FIG. 4 is a VLAN connection table as one example expressing connection states between a plurality of nodes and a plurality of VLANs in the cross-point expression shown in FIG. 3;

FIG. 5 is a view showing a configuration example of a network system according to a second embodiment;

FIG. 6 is a view showing a configuration example of a network system according to a third embodiment;

FIG. 7 is a view showing a configuration example of a network system according to a fourth embodiment;

FIG. 8 is a view showing one example of a cross-point expression according to the fourth embodiment;

FIG. 9 is a VLAN connection table according to the fourth embodiment;

FIG. 10 is a view showing a configuration example of a network system according to a fifth embodiment;

FIG. 11 is a view showing one example of a cross-point expression according to the fifth embodiment;

FIG. 12 is a VLAN connection table according to the fifth embodiment;

FIG. 13 is a view showing a configuration example of a network system according to a sixth embodiment;

FIG. 14 is a view showing one example of a cross-point expression according to the sixth embodiment;

FIG. 15 is a VLAN connection table according to the sixth embodiment;

FIG. 16 is a view showing a configuration example of a network system according to a seventh embodiment;

FIG. 17 is a view showing one example of a cross-point expression according to the seventh embodiment;

FIG. 18 is a VLAN connection table according to the seventh embodiment;

FIG. 19 is a view showing a configuration example of a network system according to an eight embodiment;

FIG. 20 is a view showing one example of a cross-point expression according to the eight embodiment;

FIG. 21 is a VLAN connection table according to the eight embodiment;

FIG. 22 is a view showing a configuration example of a network system according to the ninth embodiment;

FIG. 23 is a view showing one example of the cross-point expression according to the ninth embodiment;

FIG. 24 is a VLAN connection table according to the ninth embodiment;

FIG. 25 is a schematic block diagram showing a configuration example of an information processing apparatus (computer) to be used as a control apparatus and a communication apparatus; and

FIG. 26 is a view showing a configuration example of a network system as another embodiment of the present disclosure.

### DETAILED DESCRIPTION OF EMBODIMENTS

Hereinafter, embodiments of the present disclosure will be described with reference to the drawings.

### First Embodiment

### Outline of Network System

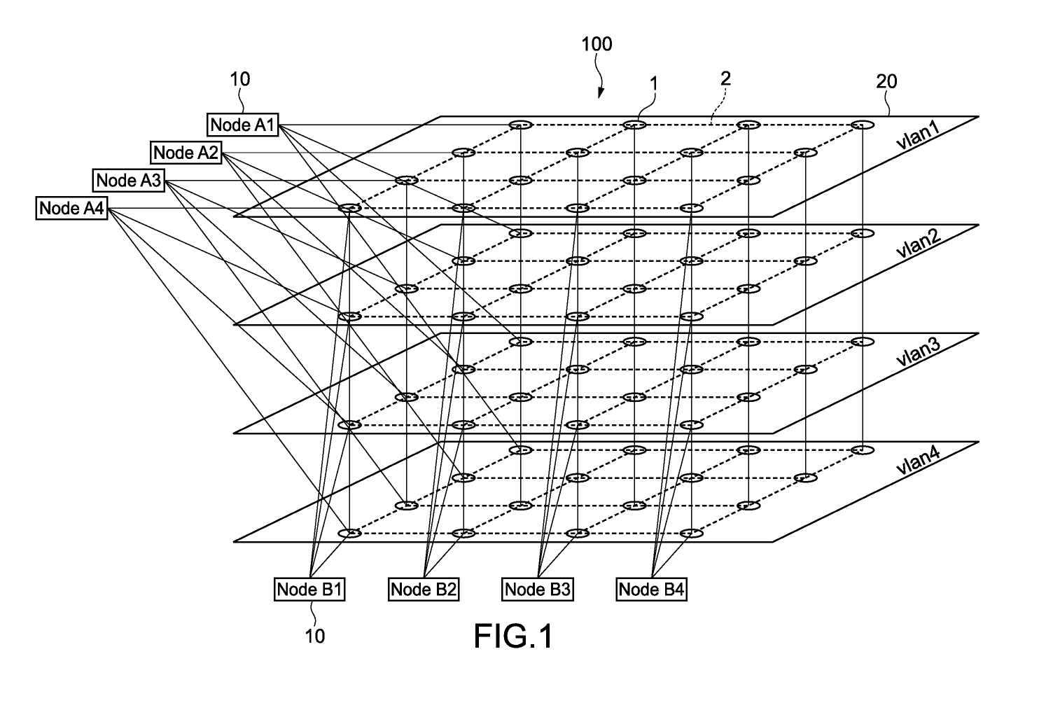

FIG. 1 is a view for explaining an outline of a network system according to a first embodiment of the present disclosure. As shown in FIG. 1, in this embodiment, a plurality of communication apparatuses 10 capable of performing packet communication are connected through a plurality of virtual local area networks (VLANs: virtual networks) 1-4 serving as a plurality of networks 20. The plurality of communication apparatuses 10 are all set to be connectable to all the plurality of VLANs 1-4.

Although FIG. 1 shows the VLANs 1-4, a VLAN 5 is also set as a control network in addition to the VLANs 1-4. In this embodiment, the VLANs 1-5 are set as the plurality of networks 20. Hereinafter, when the plurality of VLANs 1-5 are described without distinction, the plurality of VLANs 1-5 will be sometimes collectively referred to as VLANs 20.

In FIG. 1, connection states in each of the VLANs 20 are expressed by a matrix 2 including a plurality of cross-points 1. Hereinafter, a state in which all communication apparatuses are connectable to one of the VLANs 20 will be referred to as that VLAN 20 having a cross-point structure. In this embodiment, each of the plurality of VLANs 1-5 has the cross-point structure.

In such a connection state, in a network system 100 according to this embodiment, a control apparatus 30 selects a VLAN 40 to be a connection destination (connection destination network) from the plurality of VLANs 1-5. The control apparatus 30 instructs each communication apparatus 10 to connect to the selected VLAN 40. The connection destination VLAN 40 corresponds to the VLAN 20 to be used when the communication apparatus 10 performs the packet communication.

That is, in a state in which each VLAN 20 has the cross-point structure, the connection destination VLAN 40 to be used for the packet communication is appropriately controlled by the control apparatus 30. With this, the useful network system 100 usable in the packet communication between the plurality of communication apparatuses 10 is realized. Hereinafter, the network system 100 will be described in detail.

[Configuration and Operation of Network System]

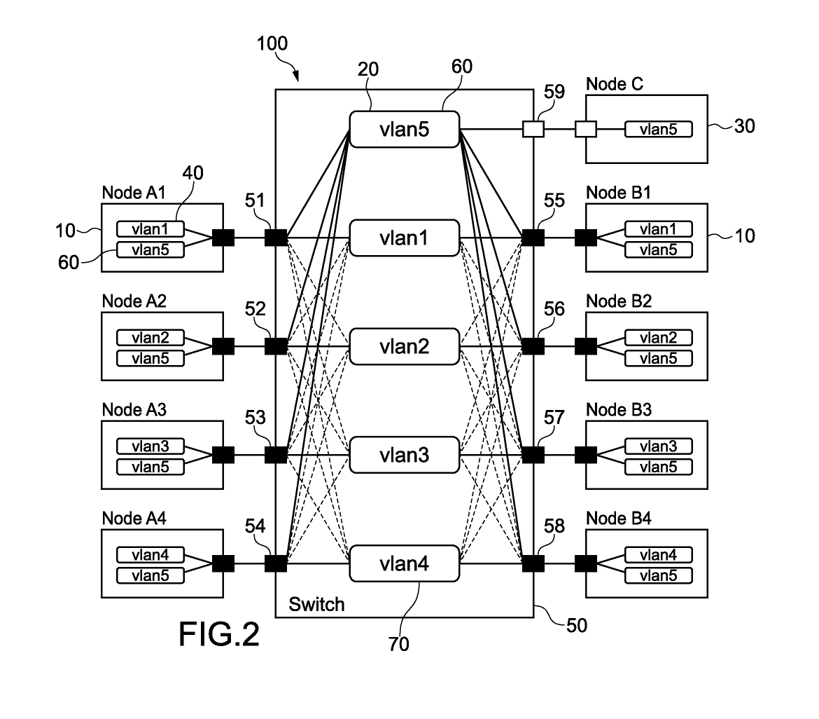

FIG. 2 is a view showing a configuration example of the network system 100 according to this embodiment. The network system 100 includes the plurality of communication apparatuses 10, a packet relay apparatus 50 to be connected to the plurality of communication apparatuses 10, and the control apparatus 30 for managing the network system 100.

Each communication apparatus 10 transmits and receives, for example, packetized video or audio data. The packets to be handled are not limited. For example, those to which error correction codes or the like are added may be communicated. Further, data different from the video or audio data may be packetized and communicated.

FIGS. 1 and 2 shows, as the plurality of communication apparatuses 10, nodes A1-A4 and nodes B1-B4 (those nodes will be sometimes collectively described as nodes 10). The nodes A1-A4 and the nodes B1-B4 are shown as groups to be communication partners that communicate with each other. That is for the sake of convenience to make descriptions understandable in association with the cross-point expression that will be described later. That is, out of the eight communication apparatuses 10 of the nodes A1-A4 and the nodes B1-B4, those having the same VLAN 20 set therebetween communicate with each other. The eight communication apparatuses 10 are not essentially different from each other.

Note that the number of nodes 10 is not limited. For example, as a larger number of VLANs 20 can be set, a larger number of nodes 10 can be connected.

The packet relay apparatus 50 includes the plurality of networks 20 for the packet communication by the plurality of communication apparatuses 10. The packet relay apparatus 50 according to this embodiment is one or more layer 2 switches including the plurality of VLANs 20 as the plurality of networks 20. Hereinafter, the packet relay apparatus 50 will be referred to as a switch 50.

A technique for setting the VLANs 1-5 in the switch 50 is not particularly limited. For example, an arbitrary technique such as a VLAN-Tag technique may be used. In this embodiment, the VLANs 1-5 are constructed as networks independent from each other. Note that the number of VLANs 20 set in the switch 50 is not limited.

As shown in FIG. 2, the switch 50 includes eight trunk ports (ULAN trunks) 51-58 and a single access port 59. The eight trunk ports 51-58 are set to be communicable with all the plurality of VLANs 1-5. That is, each of the plurality of trunk ports 51-58 is set to be communicable with all the plurality of VLANs 1-5.

To the eight trunk ports 51-58, connected are the nodes A1-A4 and the nodes B1-B4. To the trunk ports 51-54, connected are the nodes A1-A4. To the trunk ports 55-58, connected are the nodes B1-B4. Therefore, the nodes A1-A4 and the nodes B1-B4 are connected to the switch 50 such that each of the nodes A1-A4 and the nodes B1-B4 is connectable to all the plurality of VLANs 1-5.

For example, a trucking protocol for setting the trunk ports is not limited. For example, by appropriately using tags for identifying the VLANs 20, setting the trunk ports is realized. Each node 10 and the switch 50 are connected to each other via, for example, a local area network (LAN) or a wide area network (WAN).

The access port 59 is connected to only the VLAN 5 of the plurality of VLANs 1-5. Further, to the access port 59, connected is a node C that operates as the control apparatus 30 according to this embodiment.

The node C has a network management function. The node C selects the VLAN 40 to be a connection destination from the plurality of VLANs 20, and instructs each of the plurality of nodes 10 to connect to the selected VLAN 40. That is, the node C has a function of notifying the nodes A1-A4 and the nodes B1-B4 of the VLAN 20 to be used by each of the nodes A1-A4 and the nodes B1-B4.

As shown in FIG. 2, the VLAN 5 is commonly connected to the plurality of nodes 10 and the node C. This VLAN 5 is used as a control network 60. Therefore, as one of the plurality of VLANs 20, the VLAN 5, corresponds to the control network 60 to be commonly connected to the plurality of nodes 10 for an instruction of the node C.

In this embodiment, the VLANs 1-4 of the plurality of VLANs 20 excluding the VLAN 5 being the control VLAN 60 are used as a plurality of communication VLANs 70 (communication networks). The node C selects the connection destination VLAN 40 from the plurality of communication VLANs 70 and provides an instruction to connect to the selected connection destination VLAN 40 through the control VLAN 60. Therefore, the control VLAN 60 and the connection destination VLAN 40 are set in each node 10.

The node C transmits, as the instruction regarding the connection destination VLAN 40, setting information including information on the connection destination VLAN 40 and an address of the node 10 to be a communication destination. The information on the connection destination VLAN 40 is information for setting the connection destination VLAN 40 in each node 10. Typically, the information on the connection destination VLAN 40 is an identifier (ID) of the connection destination VLAN 40. The address of the communication destination node 10 is an address of another node 10 of the plurality of nodes 10 to be a communication destination of the packet communication. For example, a media access control address (MAC address) or an Internet protocol address (IP address) is used. Other information may be used.

In this embodiment, for the instruction regarding the connection destination VLAN 40, the node C is communicable with the plurality of nodes 10 by a simple network management protocol (SNMP). Otherwise, a unique protocol may be used.

Based on the setting information received from the node C, the plurality of nodes 10 perform setting for the packet communication. A protocol and the like for the setting of the packet communication based on the setting information are not limited. For example, software and the like for the setting may be installed into the nodes 10 in advance.

In the example shown in FIG. 2, by the instruction from the node C, the connection destination VLAN 40 of each node is set as follows. That is, the VLAN 1 is set in the nodes A1 and B1 and a VLAN 2 is set in the nodes A2 and B2. Further, the VLAN 3 is set in the nodes A3 and B3 and the VLAN 4 is set in the nodes A4 and B4.

Therefore, in this example, the nodes A1 and B1 are in a communicable state. The nodes A2 and B2 are in a communicable state. The nodes A3 and B3 are in a communicable state. The nodes A4 and B4 are in a communicable state. The node C changing the VLAN 20 assigned to each node 10 realizes the packet communication between particular nodes 10. While, for example, monitoring a traffic amount of each VLAN 20, the node C provides an appropriate instruction for setting the connection destination VLAN 40 for each node 10. With this, the useful network system 100 is realized.

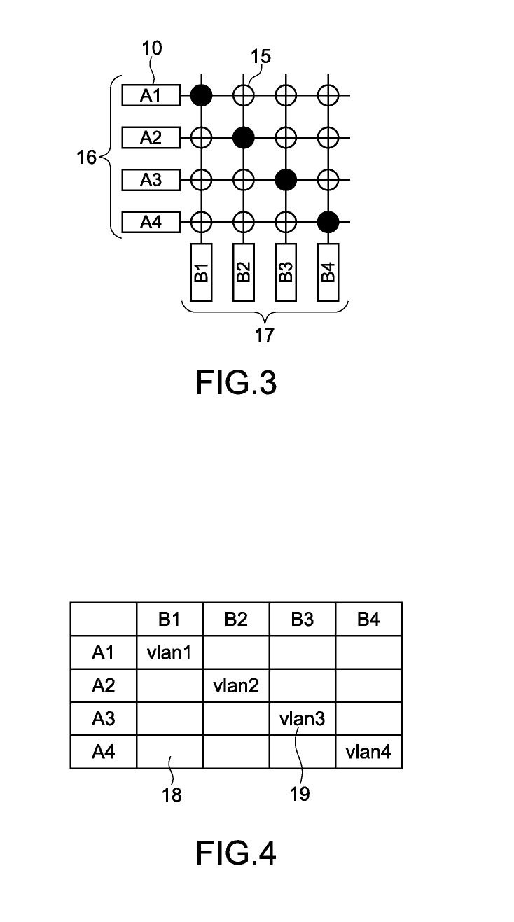

FIG. 3 is a view showing an example of a cross-point expression to be used for managing the connection states of the network system 100. FIG. 4 is a VLAN connection table as one example expressing the connection states between the plurality of nodes and the plurality of VLANs. Note that FIGS. 3 and 4 express the connection states shown in FIG. 2.

In this embodiment, the node C manages a system state including the connection states between the plurality of nodes 10 and the connection states between the plurality of nodes 10 and the plurality of VLANs 20. That is, the node C manages which of the nodes 10 and through which of the VLANs 20 are communicable with each other. The management of the system state is performed using the cross-point expression and VLAN connection table that are shown in FIGS. 3 and 4.

The cross-point expression is an expression using a plurality of cross-points 15. The plurality of cross-points 15 are expressed corresponding to connection points between the plurality of nodes 10. For example, in FIG. 3, a node group 16 consisting of the nodes A1-A4 is arranged in a vertical direction, and a node group 17 consisting of the nodes B1-B4 is arranged in a horizontal direction. Further, circle symbols (cross-points 15) between the nodes 10 between which communication is set up are expressed in black, and circle symbols between the nodes 10 between which communication is not set up are expressed in white. With this, the connection states between the nodes 10 can be easily grasped and managed.

The VLAN connection table shown in FIG. 4 is an example expressing which of the VLANs 20 constitutes the black circle in the cross-point expression shown in FIG. 3. Each cell 18 of the VLAN connection table corresponds to the cross-point 15. IDs of the used VLANs 20 are stored in the cells 19 corresponding to the black circles. With this, it becomes possible to easily grasp and manage the system state. As a result, the network system 100 can be easily managed.

When the connection destination VLAN 40, the communication destination node 10, and the like are changed by the instruction from the node C, the positions of the black circles in the cross-point expression of FIG. 3 are changed. Further, the IDs of the VLANs in the VLAN connection table of FIG. 4 and the positions of the cells 19 in which those IDs are stored are changed.

The cross-point expression is used for the management of the system state in this manner. With this, for example, based on the information shown in FIGS. 3 and 4, a network manager or a network user can know the configuration and connections of the network system 100. Such information is managed by the node C having a network management function.

Note that the VLAN connection table shown in FIG. 4 can also be considered as one example of the cross-point expression. Further, the cross-point expression is one example of an expression format for managing the configuration and the connection states of the network system 100, and other information may be used for managing the system state.

The node C may output display information for displaying the system state by the cross-point expression. That is, the node C may output display information for displaying the cross-point expression shown in FIG. 3 and the VLAN connection table shown in FIG. 4. The system state may be displayed by a display unit of the node C. Alternatively, display information may be outputted to each node 10 through the VLAN 5 and may be displayed by the node 10 receiving the display information. Thus, the system state can be displayed. As a result, the management and the like of the system state of the network system 100 are facilitated.

Hereinafter, in the network system 100 according to this embodiment, the switch 50 is provided such that each of the plurality of nodes 10 is connectable to all the plurality of VLANs 1-5. Further, the node C instructs each node 10 to connect to the VLAN 40 to be a connection destination. With this, the useful network system 100 usable in the packet communication between the plurality of nodes 10 is realized. For example, by the node C appropriately instructing each node 10 to connect to the connection destination VLAN 40, functions equivalent to those of a routing switch can be realized using the layer 2 switches 50.

Patent Document 1 above describes means for providing an effective use of the network resource and restoration of failure. As the means therefor, Patent Document 1 describes using a plurality of VLANs for connection between nodes, configuring each of the VLANs by a plurality of layer 2 switches, and switching the VLANs for restoration of failure. Connection states between the plurality of nodes and the plurality of VLANs are fixed, and the VLANs are appropriately switched upon restoration of failure or the like.

As in the network transfer system described in Patent Document 1, the plurality of VLANs are fixedly set as paths between the nodes. Only by making a setting so that paths can be appropriately selected from the plurality of VLANs, a physical topology of the layer 2 network that embodies it, for example, is not defined. Further, there may be a problem in that an effective setting method for the VLANs and the layer 2 switches against an increase of the number of nodes is unclear.

In the network system 100 according to this embodiment, the cross-point structure is set in each of the plurality of VLANs 1-5. Then, the node C provides appropriate instructions to connect to the connection destination VLAN 40. Therefore, it is possible to design a physical topology for the purpose of realizing the cross-point structure. Such a design of the physical topology can be relatively easily performed. Further, although will be described also in the following embodiments, in a network system 100 and a path setting method for a communication flow according to the present disclosure (instruction of the node C regarding connection destination VLAN), a large-scale network system can be easily constructed even if the number of nodes is increased.

### Second Embodiment

A network system according to a second embodiment of the present disclosure will be described. In the following, descriptions of the same portions as the configurations and the actions in the network system 100 according to the above-mentioned first embodiment will be omitted or simplified.

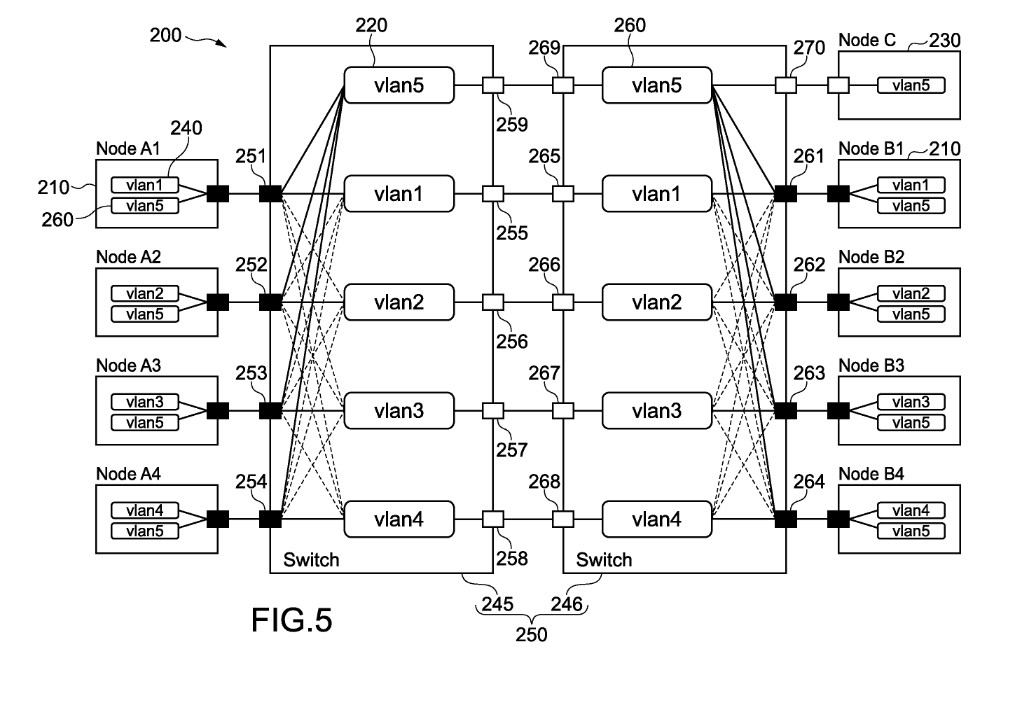

FIG. 5 is a view showing a configuration example of a network system 200 according to this embodiment. In the network system 200, two switches 245 and 246 constitute a packet relay apparatus 250. The VLANs 1-5 are set in each of the switches 245 and 246.

As shown in FIG. 5, the switch 245 includes four trunk ports 251-254 and five access ports 255-259. The four trunk ports 251-254 are set to be connectable to all of a plurality of VLANs 1-5. To the four trunk ports 251-254, are connected nodes A1-A4 being a plurality of communication apparatuses 210.

The five access ports 255-259 are connected to the plurality of VLANs 1-5, respectively. Connection combinations are (access port 255, VLAN 1), (access port 256, VLAN 2), (access port 257, VLAN 3), (access port 258, VLAN 4), and (access port 259, VLAN 5).

The switch 246 includes four trunk ports 261-264 and six access ports 265-270. The four trunk ports 261-264 are set to be communicable with all the plurality of VLANs 1-5. To the four trunk ports 261-264, connected are nodes B1-B4 being a plurality of communication apparatuses 210.

The five access ports 265-269 of the six access ports 265-270 are connected to the plurality of VLANs 1-5, respectively. Connection combinations thereof are (access port 265, VLAN 1), (access port 266, VLAN 2), (access port 267, VLAN 3), (access port 268, VLAN 4), and (access port 269, VLAN 5).

The five access ports 255-259 of the switch 245 and the five access ports 265-269 of the switch 246 are connected to one another such that those connected to the same VLAN 220 are connected to each other. With this, the packet relay apparatus 250 that includes a plurality of VLANs 220, and is to be connected to a plurality of nodes 210 such that each of the plurality of nodes 210 is connectable to all the plurality of VLANs 220 is realized.

Note that an access port 270 of the switch 246 is connected to the VLAN 5. To this access port 270, connected is a node C being a control apparatus 230. The node C transmits an instruction regarding a connection destination VLAN 240 to each node 210 through the VLAN 5 being a control VLAN 260.

The same system state as that of FIG. 2 is shown in the example of FIG. 5. Therefore, the cross-point expression and VLAN connection table for managing and displaying the system state are the same as those shown in FIGS. 3 and 4.

As described above, in this embodiment, the plurality of switches 245 and 246 constitute the packet relay apparatus 250. With this, for example, even if the nodes A1-A4 and the nodes B1-B4 are remote from each other, the network system 200 can be constructed. Note that, if the plurality of switches 245 and 246 are used, a different VLAN 220 is assigned to each access port so as not to form a loop between the switches 245 and 246.

### Third Embodiment

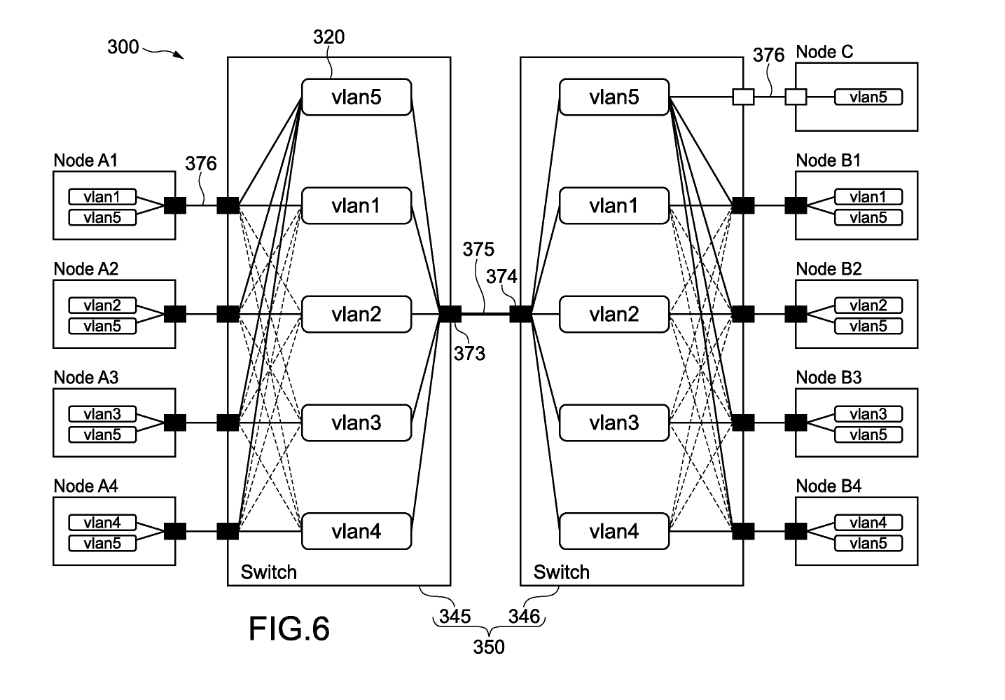

FIG. 6 is a view showing a configuration example of a network system 300 according to a third embodiment of the present disclosure. Also in this network system 300, two switches 345 and 346 constitute a packet relay apparatus 350.

A difference from the network system 200 of the second embodiment is in that the switches 345 and 346 are connected to each other through trunk ports 373 and 374. Each of the trunk ports 373 and 374 is set to be communicable with all of a plurality of VLANs 1-5. By connecting the trunk ports 373 and 374 to each other, the switches 345 and 346 are connected to each other.

In this manner, the plurality of switches 345 and 346 constituting the packet relay apparatus 350 may be connected to each other through the trunk ports 373 and 374. That is, a connection between the switches 345 and 346 is collected to a single link (trunk link) 375. For example, a link having a bandwidth higher than that of a link 376 to be used for connecting nodes A1-A4, B1-B4, and C is used as the link 375. With this, the bandwidth of each VLAN 320 can be prevented from being lowered.

### Fourth Embodiment

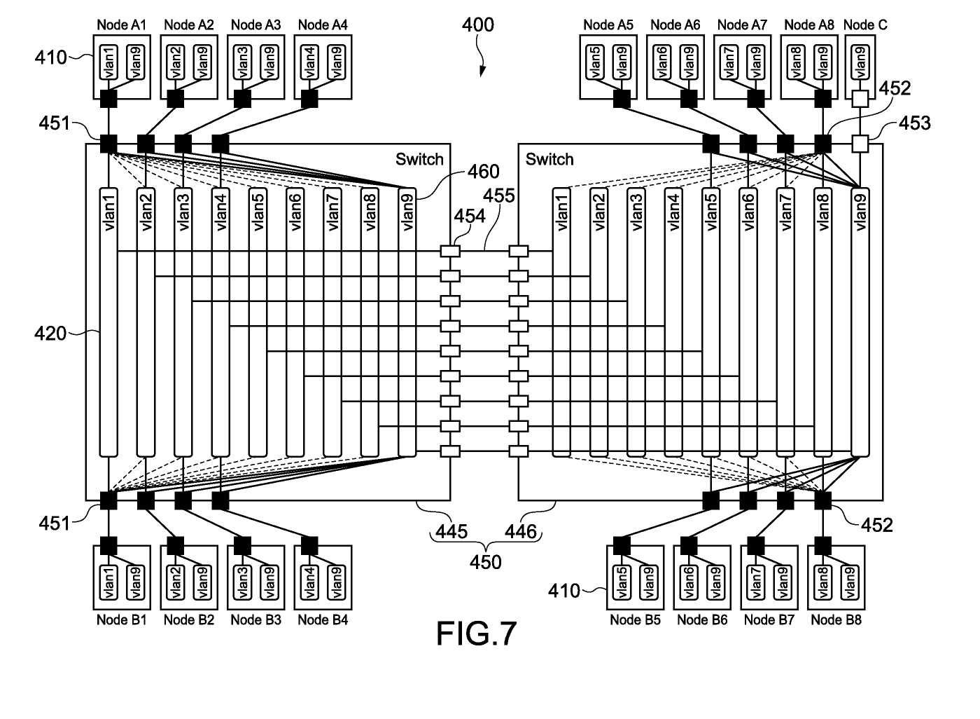

FIG. 7 is a view showing a configuration example of a network system 400 according to a fourth embodiment of the present disclosure. Here, it is assumed that the number of nodes connectable to a single switch is limited to a predetermined number excluding a node C to be a control apparatus. In this case, a configuration and a connection method for housing a larger number of nodes than the predetermined number of nodes in the network system 400 will be described.

As shown in FIG. 7, in the network system 400, two switches 445 and 446 constitute a packet relay apparatus 450. Eight trunk ports 451 (indicated by common reference symbols 451) are set in the switch 445. Eight trunk ports 452 (indicated by common reference symbols 452) and a single access port 453 are set in the switch 446. Therefore, except for the node C, only eight nodes 410 are connectable to the switches 445 and 446.

Nine VLANs 1-9 are set in each of the switches 445 and 446. Each of the nodes 410 connected to the switches 445 and 446 is set to be connectable to all the VLANs 1-9. Note that, in FIG. 7, some connection lines are omitted in order to avoid complications.

The VLANs 1-9 set in the switches 445 and 446 are connected for each VLAN 420 by a link 455 through access ports 454 (indicated by common reference symbols 452). As shown in FIG. 7, the VLAN 9 is connected to the node C through the access port 453. That is, the VLAN 9 is used as a control VLAN 460. Note that a plurality of links 455 can be collected to fewer links as in the third embodiment, for example.

With such a configuration, sixteen nodes 410 twice the number of trunk ports 451 (452) set in the single switch 445 (446) can be housed in the network system 400. That is, a larger number of VLANs 420 than the number of trunk ports 451 (452) are set, and hence the number of nodes 410 that can be housed in the network system 400 can be increased. As a result, a large-scale network system 400 can be easily constructed even if the number of nodes is increased.

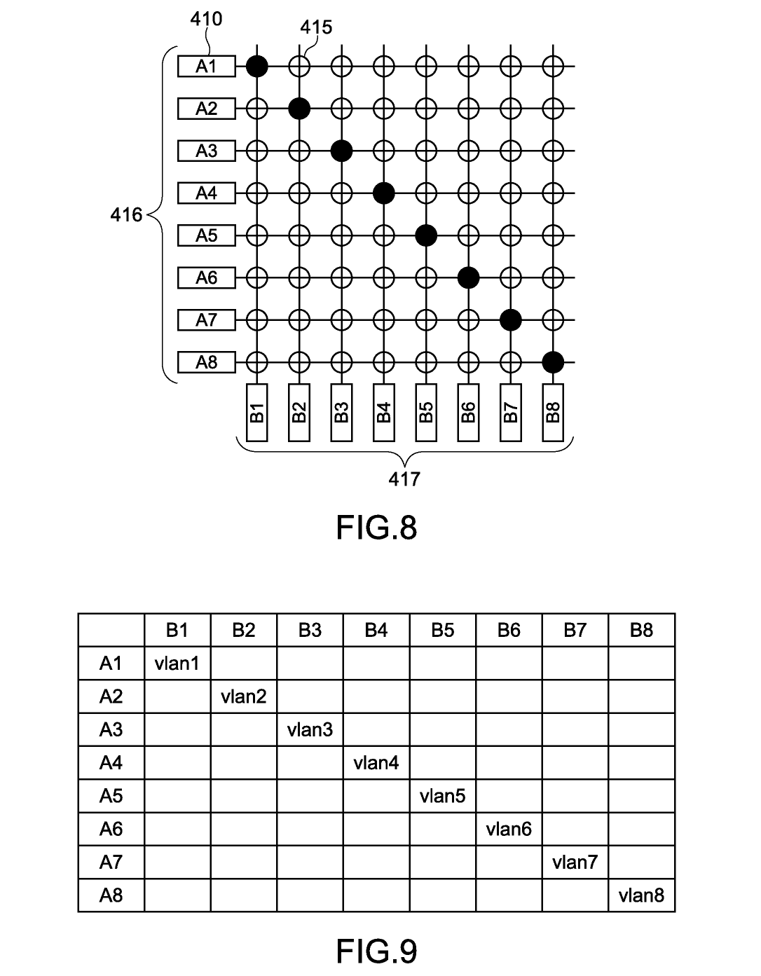

FIG. 8 is a view showing an example of a cross-point expression to be used for managing connection states of the network system 400. FIG. 9 is a VLAN connection table as one example expressing a system state. Note that, in FIGS. 8 and 9, the connection states shown in FIG. 7 are expressed.

In FIG. 8, a node group 416 consisting of nodes A1-A8 is arranged in the vertical direction and a node group 417 consisting of nodes B1-B8 is arranged in the horizontal direction. Further, circle symbols (cross-points 415) between the nodes 410 between which communication is set up are expressed in black, and circle symbols between the nodes 410 between which communication is not set up are expressed in white. In a VLAN connection table shown in FIG. 9, which of the VLANs 420 constitutes each black circle in the cross-point expression shown in FIG. 8 is expressed.

Using the cross-point expression in this manner, it is possible to easily grasp and manage the system state even if the scale of the network system 400 is increased due to an increase of the number of nodes. The node C may output display information for displaying the cross-point expression shown in FIG. 8 and the VLAN connection table shown in FIG. 9.

### Fifth Embodiment

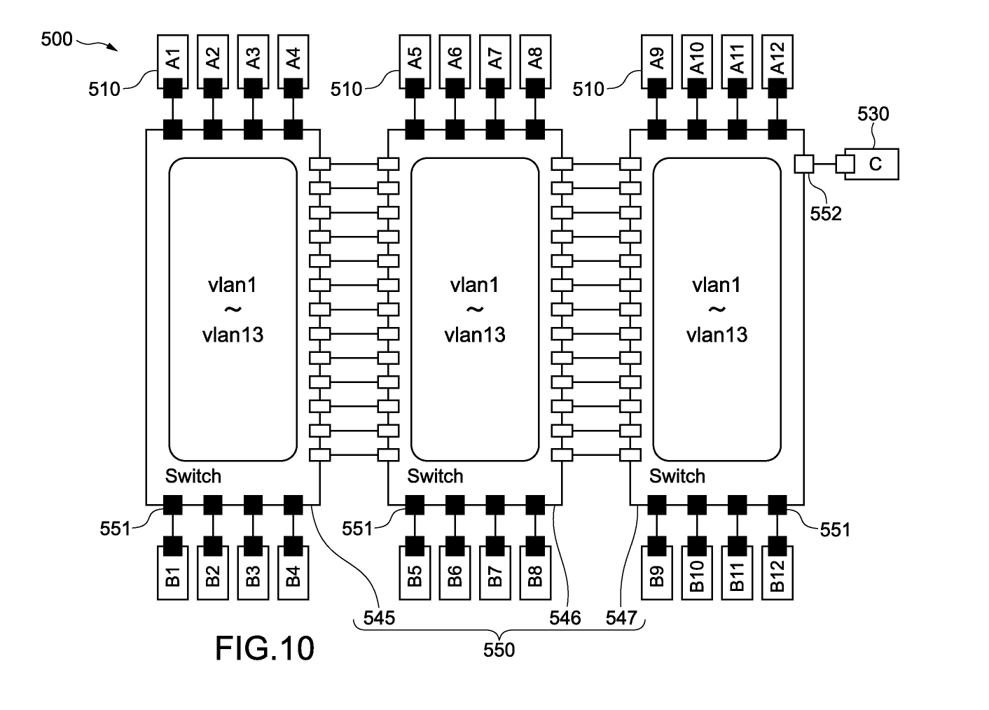

FIG. 10 is a view showing a configuration example according to a network system 500 of a fifth embodiment of the present disclosure. In FIG. 10, some connection lines are omitted in order to avoid complications.

In this embodiment, three switches 545-547 constitute a packet relay apparatus 550. Each of the switches 545-547 includes eight trunk ports 551. Thirteen VLANs 1-13 are set in each of the switches 545-547. To the switch 547, connected is a node C being a control apparatus 530 through an access port 552. To the access port 552, connected is the VLAN 13. The VLAN 13 is used as a control VLAN. Other than this, it is sufficient that connections of a plurality of nodes 510 with the switches 545-547, connections between the switches 545-547, and the like are the same as those in the above-mentioned fourth embodiment.

The network system 500 having such a configuration can house twenty-four nodes 510, in other words, a further larger number of nodes than those in the network system 400 according to the above-mentioned fourth embodiment (except for node C). By increasing the number of switches 545-547 in this manner, the large-scale network system 500 can be easily constructed.

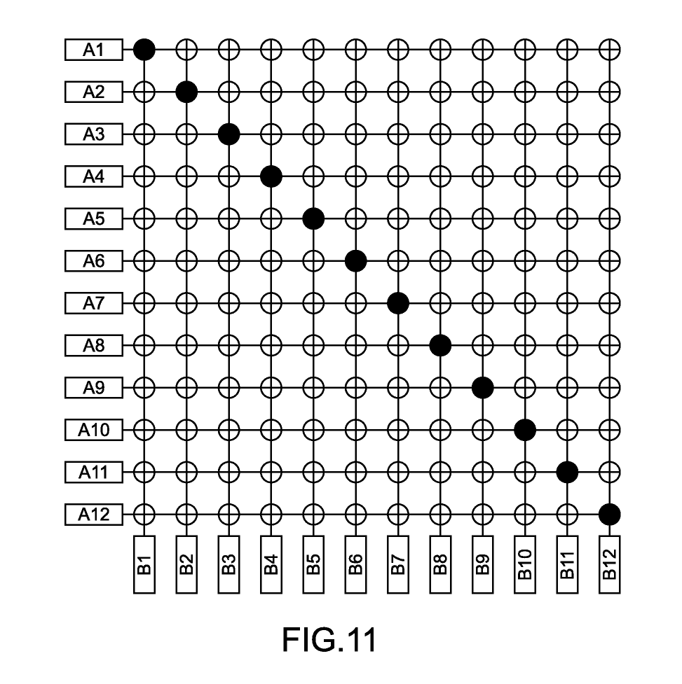

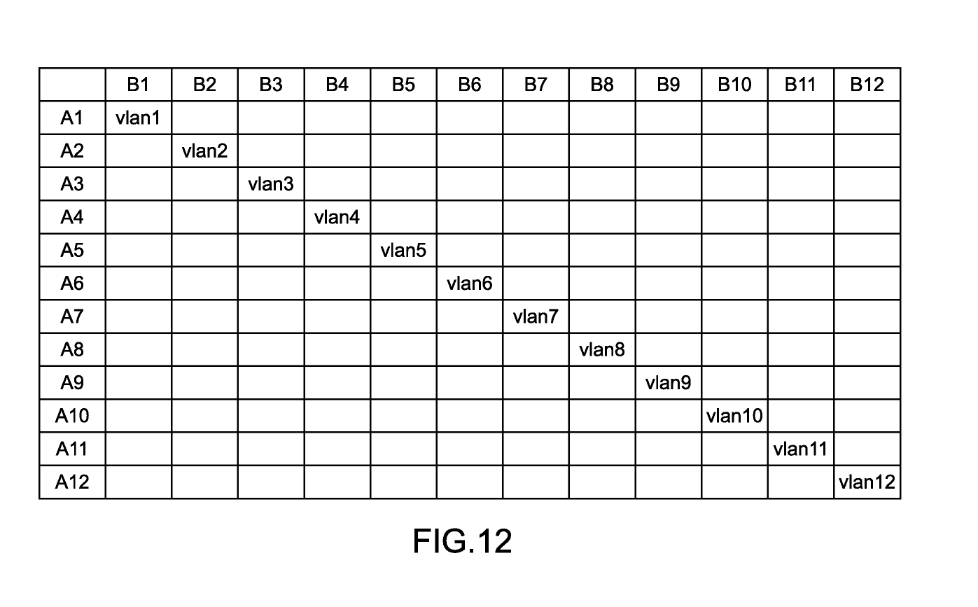

FIG. 11 is a view showing an example of a cross-point expression to be used for managing connection states of the network system 500. FIG. 12 is a VLAN connection table as one example expressing a system state. Note that FIGS. 11 and 10 show one example of the system state.

Using the cross-point expression, it is possible to easily grasp and manage the system state even if the scale of the network system 500 is increased due to a further increase of the number of nodes. Display information for displaying the cross-point expression shown in FIG. 11 and the VLAN connection table shown in FIG. 12 may be outputted.

### Sixth Embodiment

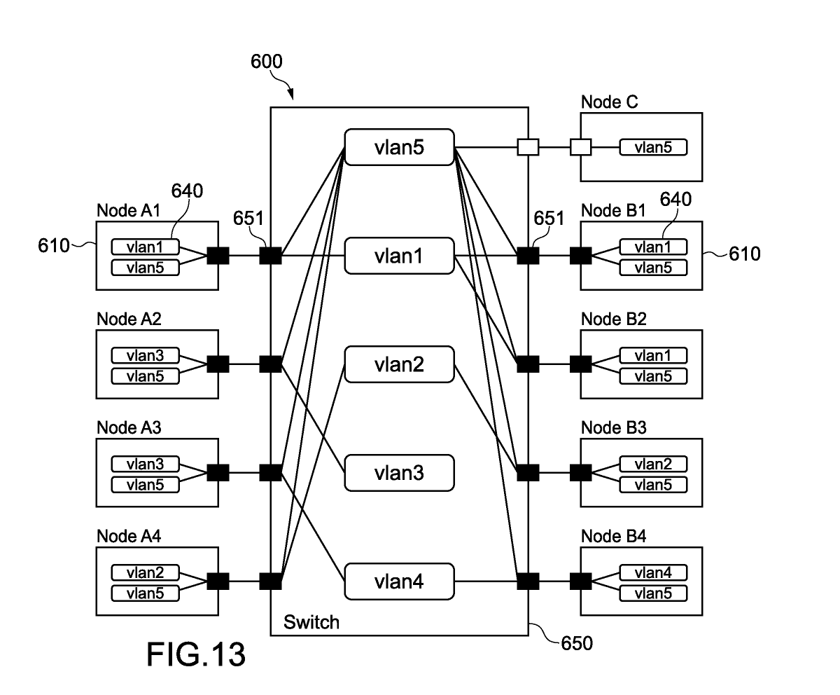

FIG. 13 is a view showing a configuration example of a network system 600 according to a sixth embodiment of the present disclosure. In FIG. 13, only connection lines in which connections are established in the switch 650 are shown. However, settings of the switch 650 are the same as those in the above-mentioned first embodiment. That is, each trunk port 651 is set to be connectable to all of VLANs 1-5. Therefore, each node 610 is connectable to all the VLANs 1-5.

In the network system 600 according to this embodiment, by an instruction of a node C, multi-cast communication between the nodes 610 is realized. In FIG. 13, connection destinations VLAN 640 of a node A1, a node B1, and a node B2 are all set to the VLAN 1. With this, multi-cast communication using the VLAN 1 from the node A1 to the node B1 and the node B2 becomes possible. By controlling the instruction regarding the connection destination VLAN 640 by the node C in this manner, the multi-cast communication can be realized. Of course, multi-cast communication may be performed for two or more nodes.

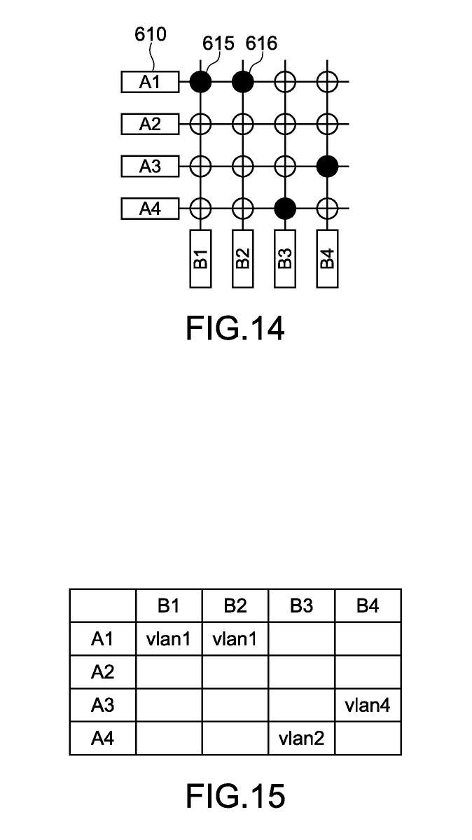

FIG. 14 is a view showing an example of a cross-point expression to be used for managing connection states of the network system 600. FIG. 15 is a VLAN connection table as one example expressing a system state. Note that, in FIGS. 14 and 15, the system state shown in FIG. 13 is expressed.

In the cross-point expression shown in FIG. 14, circle symbols 615 between the node A1 and the node B1 and circle symbols 616 between the node A1 and the node B2 are expressed in black. Further, the VLAN connection table of FIG. 15 expresses the VLAN 1 constituting each of the black circles of the circle symbols 615 and 616. Based on such information, it is possible to easily grasp the fact that the multi-cast communication is performed, and to manage the system state.

### Seventh Embodiment

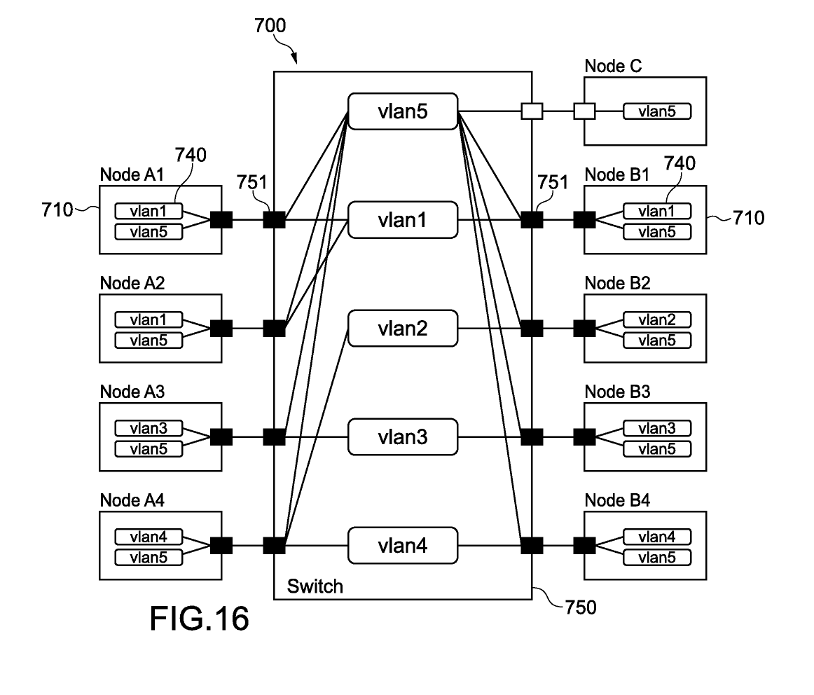

FIG. 16 is a view showing a configuration example of a network system 700 according to a seventh embodiment of the present disclosure. In FIG. 16, only connection lines in which connections are established in the switch 750 are shown. However, switch settings are the same as those in the above-mentioned first embodiment. Each trunk port 751 is set to be connectable to all of VLANs 1-5.

In the network system 700 according to this embodiment, communication in which a plurality of flows are received by a single node 710 is performed by an instruction of a node C. In FIG. 16, connection destinations VLAN 740 of a node A1, a node A2, and a node B1 are all set to the VLAN 1. With this, communication using the VLAN 1 from both of the node A1 and the node A2 to the node B1 becomes possible.

By controlling the instruction regarding the connection destination VLAN 740 by the node C, such communication can be realized. Note that a protocol and the like for receiving each of packets from the node A1 and packets from the node A2 are not limited. Further, of course, communication from three or more nodes 710 to a single node 710 may be performed.

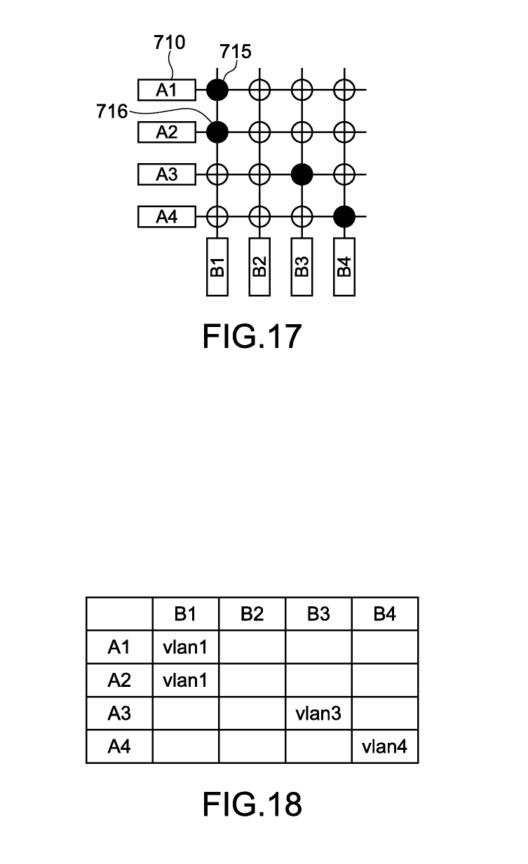

FIG. 17 is a view showing an example of a cross-point expression to be used for managing connection states of the network system 700. FIG. 18 is a VLAN connection table as one example expressing a system state. Note that, in FIGS. 17 and 18, the system state shown in FIG. 16 is expressed.

In the cross-point expression shown in FIG. 17, circle symbols 715 between the node A1 and the node B1 and circle symbols 716 between the node A2 and the node B1 are expressed in black. Further, the VLAN connection table of FIG. 18 expresses the VLAN 1 constituting each of the black circles of the circle symbols 715 and 716. Based on such information, it is possible to easily grasp the fact that the communication in which the plurality of flows are received by the single node is performed, and to manage the system state.

### Eighth Embodiment

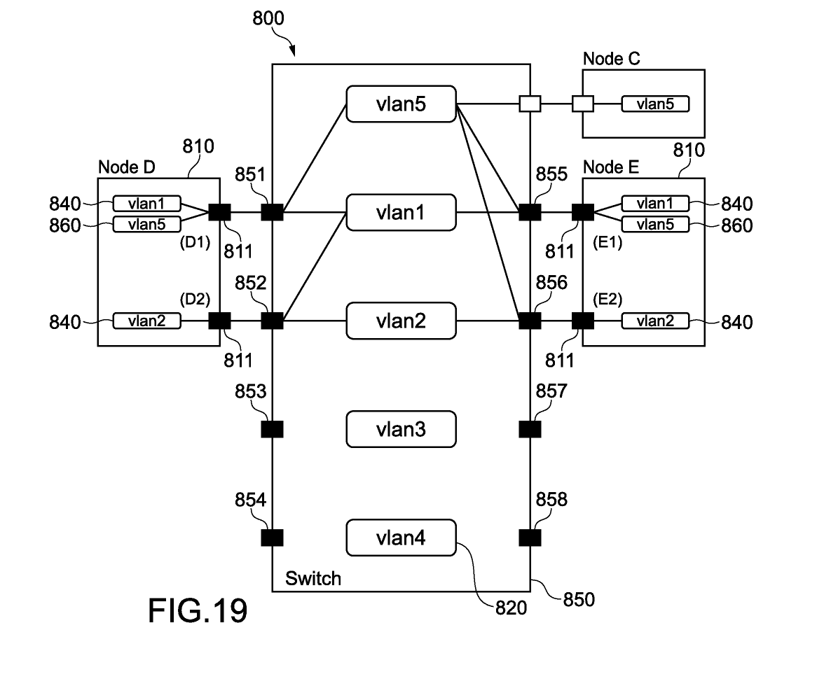

FIG. 19 is a configuration example of the network system 800 according to an eighth embodiment of the present disclosure. In FIG. 19, only connection lines in which connections are established in the switch 850 are shown. Settings of the switch are the same as those in the above-mentioned first embodiment. Each of trunk ports 851-858 is set to be connectable to all of VLANs 1-5.

In the network system 800 according to this embodiment, as a node 810 for packet communication, a node including a plurality of network interfaces 811 is used. As shown in FIG. 19, a node D includes two interfaces D1 and D2. The interface D1 is connected to a trunk port 851 of the switch 850. The interface D2 is connected to a trunk port 852. Note that three or more interfaces 811 may be provided.

The VLAN 5 is set as a control VLAN 860 via the interface D1. Further, via the same interface D1, the VLAN 1 is set as a connection destination VLAN 840. In addition, the VLAN 2 is set as the connection destination VLAN 840 via the interface D2.

Further, a node E includes two interfaces E1 and E2. The interface E1 is connected to a trunk port 855 of the switch 850. The interface E2 is connected to a trunk port 856. The VLAN 5 being the control VLAN 860 and the VLAN 1 serving as the connection destination VLAN 840 are set via the interface E1. In addition, the VLAN 2 is set as the connection destination VLAN 840 via the interface E2.

By such an instruction of the node C, the interfaces D1 and E1 can communicate with each other through the VLAN 1. Further, the interfaces D2 and E2 can communicate with each other through the VLAN 2.

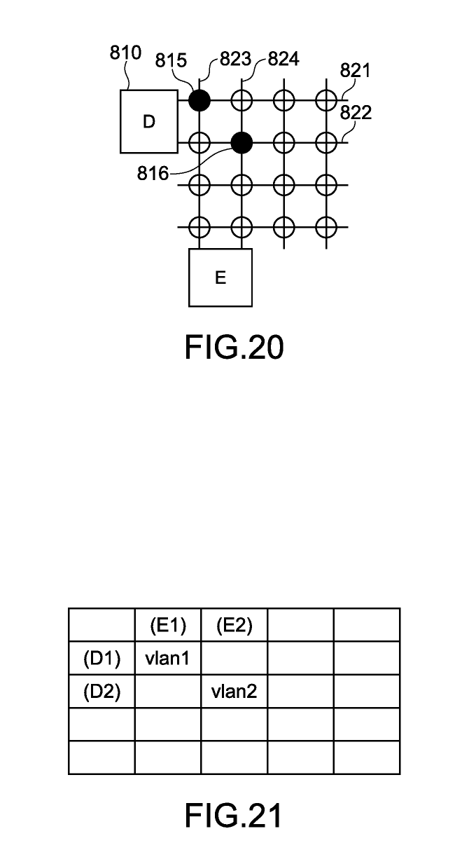

FIG. 20 is a view showing an example of a cross-point expression to be used for managing connection states of the network system 800. FIG. 21 is a VLAN connection table as one example expressing a system state. Note that, in FIGS. 20 and 21, the system state shown in FIG. 19 is expressed.

In the cross-point expression shown in FIG. 20, to nodes D and E, connected are two lines (lines 821 and 822 and lines 823 and 824, respectively). Those lines are associated with interfaces D1 and D2 and interfaces E1 and E2.

Further, a cross-point 815 on the lines 821 and 823 and a cross-point 816 on the lines 822 and 824 are expressed by the black circles. In the VLAN connection table shown in FIG. 21, IDs of the two interfaces D1 and D2 of the node D and IDs of the two interfaces D1 and D2 of the node E are stored. Further, an ID of a VLAN 820 constituting the black circle between the interfaces is stored.

Hereinafter, in this embodiment, the node including the plurality of network interfaces 811 is used as the node 810 that performs the packet communication. That is, the two or more VLANs 820 of the plurality of VLANs 1-5 are each set to the connection destination VLAN 840, and the node 810 connectable to the two or more connection destinations VLAN 840 at the same time is used.

Even if such a node is used, it is possible to easily grasp and manage the system state of the network system 800 by managing and displaying information using the cross-point expressions as shown in FIGS. 20 and 21.

### Ninth Embodiment

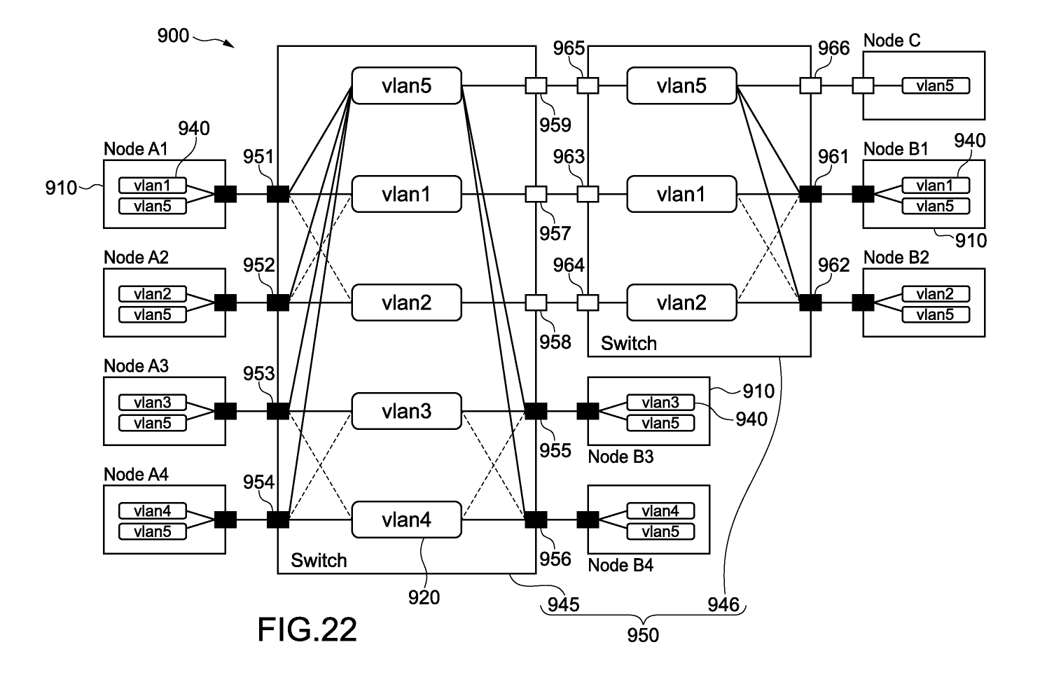

FIG. 22 is a view showing a configuration example of a network system 900 according to a ninth embodiment of the present disclosure. In this embodiment, combinations of connectable nodes 910 are limited between a plurality of nodes 910.

As shown in FIG. 22, switches 945 and 946 constitute a packet relay apparatus 950. Five VLANs 1-5 are set in the switch 945. On the other hand, three VLANs 1, 2, and 5 are set in the switch 946.

The switch 945 includes six trunk ports 951-956 and three access ports 957-959. To those ports, connected are the plurality of nodes 910 and three access ports 963-965 of the switch 946. In the following, switch settings between the ports and the VLANs 1-5 and connection settings between the ports and the nodes or the like are described. The VLANs 920 noted in brackets following the port names are the VLANs 920 connectable to those ports. The nodes or the like following the bracket are the nodes or the like to be connected to those ports.

trunk port 951 (VLANs 1, 2, and 5) node A1

trunk port 952 (VLANs 1, 2, and 5) node A2

trunk port 953 (VLANs 3, 4, and 5) node A3

trunk port 954 (VLANs 3, 4, and 5) node A4

trunk port 955 (VLANs 3, 4, and 5) node B3

trunk port 956 (VLANs 3, 4, and 5) node B4

access port 957 (VLAN 1) access port 963

access port 958 (VLAN 2) access port 964

access port 959 (VLAN 5) access port 965

The switch 946 includes two trunk ports 961 and 962 and four access ports 963-966. Switch settings and connection settings relating to those ports are described in the following.

trunk port 961 (VLANs 1, 2, and 5) node B1

trunk port 962 (VLANs 1, 2, and 5) node B2

access port 963 (VLAN 1) access port 957

access port 964 (VLAN 2) access port 958

access port 965 (VLAN 5) access port 959

access port 966 (VLAN 5) node C

As will be also seen from such switch settings and connection settings, the packet relay apparatus 950 according to this embodiment includes the plurality of VLANs 1-5 for the packet communication. The packet relay apparatus 950 is connected to the plurality of nodes 910 such that each of the plurality of nodes 910 is connectable to at least two VLANs 920 of the plurality of VLANs 1-5. Then, the node C being the control apparatus selects a connection destination VLAN 940 from the plurality of VLANs 920 and instructs each of the plurality of nodes 910 to connect to the selected connection destination VLAN 940 via the packet relay apparatus 950.

As a result, the nodes A1 and A2 is communicable with the node B1 and the node B2 via the switches 945 and 946. At this time, the VLAN 1 or the VLAN 2 is used. On the other hand, communication of the nodes A1 and A2 with the nodes B3 and B4 is limited.

The nodes A3 and A4 are communicable with the nodes B3 and B4 within the switch 945. At this time, the VLAN 3 or the VLAN 4 is used. On the other hand, the communication of the nodes A3 and A4 with the nodes B1 and B2 is limited.

As described above, each node 910 may be connectable to not all the VLANs 920, and each node 910 may be connectable to the two or more VLANs 920. The node C selects the connection destination VLAN 940 from two or more VLANs 920 to which each node 910 is connectable, and instructs the node 910 to connect to the selected connection destination VLAN 940. With such a configuration, it is possible to realize a useful network system 900 usable in the packet communication between the plurality of nodes 910.

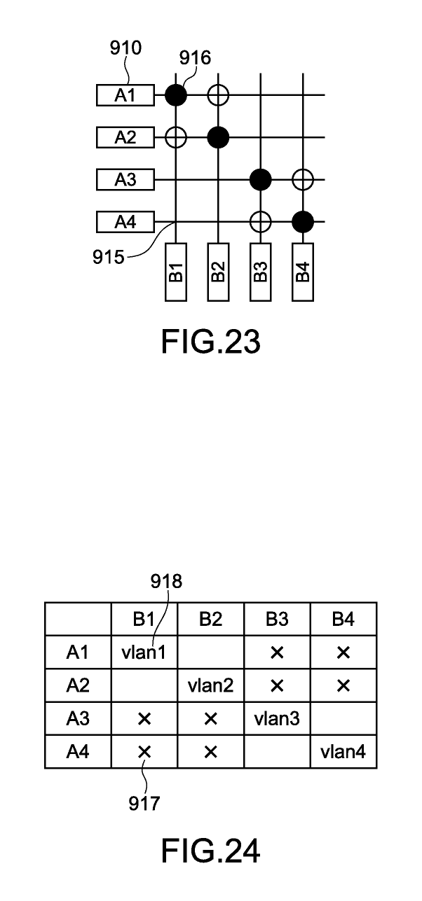

FIG. 23 is a view showing an example of a cross-point expression to be used for managing connection states of the network system 900. FIG. 24 is the VLAN connection table as one example expressing the system state. Note that, in FIGS. 23 and 24, the system state shown in FIG. 22 is expressed.

In the cross-point expression shown in FIG. 23, the circle symbols are not set at cross-points 915 between the nodes 910 between which connections are limited. The circle symbols are set only at cross-points 916 between the nodes 910 connectable to each other. The circle symbols between which communication is set up are indicated in black. With this, the connection states between the nodes 910 also including connection limitations can be easily grasped and managed.

In the VLAN connection table shown in FIG. 24, in cells 917 corresponding to the cross-points 915 between the nodes 910 in which connections are limited, symbols x expressing disconnectability are stored. In connectable cells 918, IDs of VLANs used in communication are stored. It is possible to easily grasp and manage the system state of the network system 900 by managing and displaying information using the cross-point expressions as shown in FIGS. 23 and 24.

As described in the each of the embodiments, in the network system according to the present disclosure, it becomes easy to consider the scale under a network configuration condition associated with the number of nodes and the number of layer 2 switches. Further, without changing the switch settings, the system state can be appropriately changed.

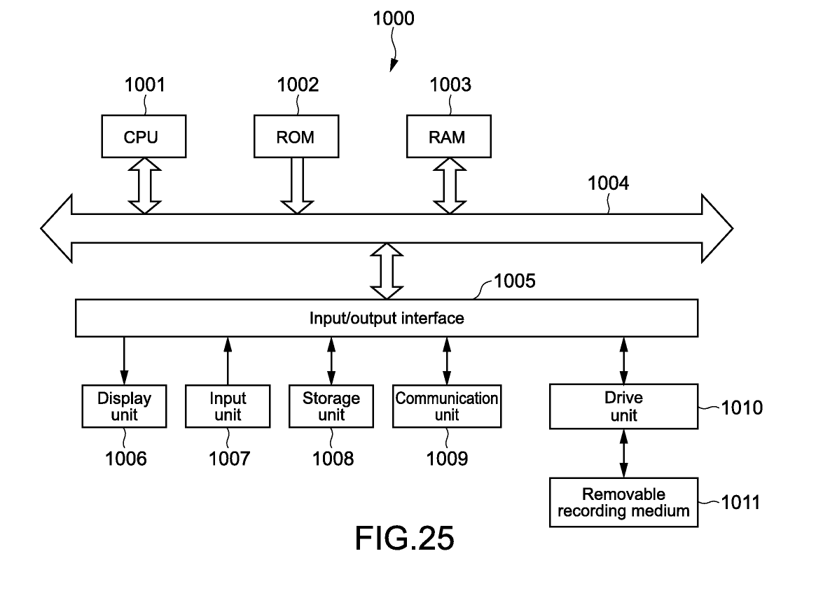

As the control apparatus and the communication apparatus in each of the above-mentioned embodiments, for example, various information processing apparatuses (computers) such as a personal computer (PC) are used. FIG. 25 is a schematic block diagram showing a configuration example of such an information processing apparatus.

An information processing apparatus 1000 includes a central processing unit (CPU) 1001, a read only memory (ROM) 1002, a random access memory (RAM) 1003, an input/output interface 1005, and a bus 1004 that connects to one another.

To the input/output interface 1005, connected are a display unit 1006, an input unit 1007, a storage unit 1008, a communication unit 1009, a drive unit 1010, and the like.

The display unit 1006 is, for example, a display device using a liquid-crystal, an electro-luminescence (EL), a cathode ray tube (CRT), or the like.

The input unit 1007 is, for example, a controller, a pointing device, a keyboard, a touch panel, and another operation apparatus. If the input unit 1007 includes the touch panel, the touch panel may be integral with the display unit 1006.

The storage unit 1008 is a non-volatile storage device, and, for example, a hard disk drive (HDD), a flash memory, or another solid-state memory.

The drive unit 1010 is, for example, a device capable of driving a removable recording medium 1011 such as an optical recording medium, a floppy (registered trademark) disc, a magnetic recording tape, and a flash memory. In contrast, the above-mentioned storage unit 1008 is often used as a device installed in the information processing apparatus 1000 in advance, the device mainly driving a non-removable recording medium.

The communication unit 1009 is a modem, a router, or another communication apparatus for communicating to a different device, the communication unit 1009 being connectable to the LAN, a wide area network (WAN), or the like. The communication unit 1009 may perform communication in a wired manner or wireless manner. The communication unit 1009 is often used separate from the information processing apparatus 1000.

Information processing by the information processing apparatus 1000 having the above-mentioned hardware configuration is realized by the cooperation of software stored the storage unit 1008, the ROM 1002, or the like and a hardware resource of the information processing apparatus 1000. Specifically, in order to realize such information processing, the CPU 1001 loads programs configuring the software that are stored in the storage unit 1008, the ROM 1002, or the like into the RAM 1003 and execute the programs.

The programs are installed into the information processing apparatus 1000 via, for example, a recording medium. Alternatively, the programs may be installed into the information processing apparatus 1000 through a global network or the like.

### Other Embodiments

The present disclosure is not limited to the above-mentioned embodiments and various other embodiments may be realized.

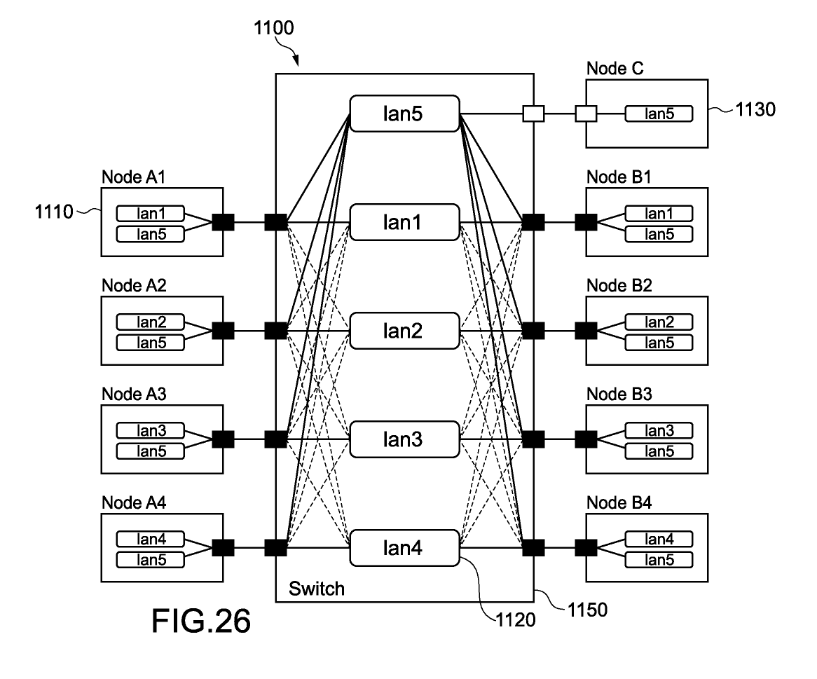

For example, FIG. 26 is a view showing a configuration example of a network system as another embodiment of the present disclosure. In a network system 1100, one or more layer 3 switches including a plurality of local area networks (LAN) as a plurality of networks 1120 are used as a packet relay apparatus 1150. As will be seen from the figure, the plurality of LANs may be used as the plurality of networks.

Operations of the node C as a control apparatus 1130 and nodes as a plurality of communication apparatuses 1110 are the same as the operations described above. As in the network system 1100, the plurality of VLANs may be replaced by the plurality of LANs in each of the above-mentioned embodiments. For example, appropriately using IP addresses and the like, instructions regarding a connection destination LAN and a communication destination node are provided.

For example, the connection destination network may be fixed to the nodes. That is, the control apparatus may constantly instruct the nodes to connect to the same network as the connection destination network. Further, in addition to the plurality of nodes provided with instructions regarding the connection destination network, a node for communication connected only to a single network through an access port may be further provided.

In the VLAN connection table shown in FIG. 4 or the like, other information on a bandwidth and the like relating to each VLAN may be stored. With this, the system state of the network can be better grasped and managed.

At least two features of the features of each of the above-mentioned embodiments may be combined.

It should be noted that the present disclosure may also take the following configurations.

(1) A network system, including:

a plurality of communication apparatuses configured to be capable of performing packet communication;

a packet relay apparatus including a plurality of networks for the packet communication and configured to be connected to the plurality of communication apparatuses such that each of the plurality of communication apparatuses is connectable to at least two networks of the plurality of networks; and

a control apparatus configured to select a network to be a connection destination from the plurality of networks and instruct each of the plurality of communication apparatuses to connect to the selected network via the packet relay apparatus.

(2) The network system according to Item (1), in which

the packet relay apparatus is configured to be connected to the plurality of communication apparatuses such that each of the plurality of communication apparatuses is connectable to all the plurality of networks.

(3) The network system according to Item (1) or (2), in which

the packet relay apparatus includes one or more layer 2 switches including a plurality of virtual local area networks (VLANs) as the plurality of networks.

(4) The network system according to Item (1) or (2), in which

the packet relay apparatus is one or more layer 3 switches including a plurality of local area networks (LANs) as the plurality of networks.

(5) The network system according to any one of Items (1) to (4), in which

the packet relay apparatus includes, as one of the plurality of networks, a control network configured to be commonly connected to the plurality of communication apparatuses for the instruction of the control apparatus, and

the control apparatus is configured to select the connection destination network from a plurality of communication networks of the plurality of networks excluding the control network and instruct each of the plurality of communication apparatuses to connect to the selected connection destination network through the control network.

(6) The network system according to any one of Items (1) to (5), in which

the control apparatus is configured to manage, using a cross-point expression, a system state including
a connection state between the plurality of communication apparatuses, and
connection states between the plurality of communication apparatuses and the plurality of networks.
   (7) The network system according to Item (6), in which

the control apparatus is configured to output display information for displaying the system state by the cross-point expression.

(8) The network system according to any one of Items (1) to (7), in which

the control apparatus is configured to transmit, as the instruction regarding the connection destination network, setting information including
information on the connection destination network and
an address of a communication apparatus to be a communication destination of the packet communication out of the plurality of communication apparatuses.
   (9) The network system according to Item (8), in which

the communication apparatus is configured to perform, based on the setting information received from the control apparatus, setting for the packet communication.

(10) The network system according to any one of Items (1) to (9), in which

the communication apparatus is configured to be connectable, with each of two or more networks of the plurality of networks being the network to be the connection destination, to two or more connection destination networks at the same time.

(11) The network system according to any one of Items (1) to (10), in which

the control apparatus is configured to communicate, for the instruction, with the communication apparatus by a simple network management protocol (SNMP).

The present disclosure contains subject matter related to that disclosed in Japanese Priority Patent Application JP 2012-201345 filed in the Japan Patent Office on Sep. 13, 2012, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A network system, comprising:
a plurality of communication apparatuses configured to be capable of performing packet communication;
a packet relay apparatus including a plurality of networks for the packet communication and configured to be connected to the plurality of communication apparatuses such that each of the plurality of communication apparatuses is connectable to at least two networks of the plurality of networks; and
a control apparatus configured to select a network to be a connection destination from the plurality of networks and instruct each of the plurality of communication apparatuses to connect to the selected network via the packet relay apparatus.

2. The network system according to claim 1, wherein
the packet relay apparatus is configured to be connected to the plurality of communication apparatuses such that each of the plurality of communication apparatuses is connectable to all the plurality of networks.

3. The network system according to claim 1, wherein
the packet relay apparatus includes one or more layer 2 switches including a plurality of virtual local area networks (VLANs) as the plurality of networks.

4. The network system according to claim 1, wherein
the packet relay apparatus is one or more layer 3 switches including a plurality of local area networks (LANs) as the plurality of networks.

5. The network system according to claim 1, wherein
the packet relay apparatus includes, as one of the plurality of networks, a control network configured to be commonly connected to the plurality of communication apparatuses for the instruction of the control apparatus, and
the control apparatus is configured to select the connection destination network from a plurality of communication networks of the plurality of networks excluding the control network and instruct each of the plurality of communication apparatuses to connect to the selected connection destination network through the control network.

6. The network system according to claim 1, wherein
the control apparatus is configured to manage, using a cross-point expression, a system state including
a connection state between the plurality of communication apparatuses, and
connection states between the plurality of communication apparatuses and the plurality of networks.

7. The network system according to claim 6, wherein
the control apparatus is configured to output display information for displaying the system state by the cross-point expression.

8. The network system according to claim 1, wherein
the control apparatus is configured to transmit, as the instruction regarding the connection destination network, setting information including
information on the connection destination network and
an address of a communication apparatus to be a communication destination of the packet communication out of the plurality of communication apparatuses.

9. The network system according to claim 8, wherein
the communication apparatus is configured to perform, based on the setting information received from the control apparatus, setting for the packet communication.

10. The network system according to claim 1, wherein
the communication apparatus is configured to be connectable, with each of two or more networks of the plurality of networks being the network to be the connection destination, to two or more connection destination networks at the same time.

11. The network system according to claim 1, wherein
the control apparatus is configured to communicate, for the instruction, with the communication apparatus by a simple network management protocol (SNMP).
